(19) United States
(12) Patent Application Publication
(10) Pub. No.: US 2011/0002210 A1
(43) Pub. Date: Jan. 6, 2011

(54) METHOD FOR CALIBRATING ACTUATOR

(75) Inventors: I-Bing SU, Taoyuan County (TW); Chi-Hsiang Kuo, Taoyuan County (TW)

Correspondence Address: RABIN & Berdo, PC, 1101 14TH STREET, NW, SUITE 500, WASHINGTON, DC, 20005, US

(73) Assignee: QUANTA STORAGE INC., Taoyuan County (TW)

(21) Appl. No.: 12/825,947

(22) Filed: Jun. 29, 2010

(30) Foreign Application Priority Data
Jul. 2, 2009 (TW) 98122539

(51) Int. Cl. G11B 27/36

(52) U.S. Cl. 369/53.25; G9B/27.052

(57) ABSTRACT

A method for calibrating an actuator is provided. A reflective reference surface is set. An objective lens is shifted to several calibration positions along the tracking direction in the actuator, focusing is performed at each position, and the shift volt and the focus volt are recorded. The focus volt at a calibration position is set as a standard focus volt, and the focus volt bias at the other calibration position with respect to the standard focus volt is calculated. A focus volt bias curve is formed by curve-fitting the focus volt bias and the shift volt at each calibration position, and a focus volt bias is obtained to compensate the volt along the focusing direction.

This application claims the benefit of Taiwan application Serial No. 98122539, filed Jul. 2, 2009, the subject matter of which is incorporated herein by reference.

### BACKGROUND OF THE INVENTION

1. Field of the Invention

The invention relates in general to a method for calibrating an actuator, and more particularly to a method which shifts the objective lens by an actuator for calibrating the bias error in an optical pick-up head of an optical disc drive.

2. Description of the Related Art

In general, the optical pick-up head uses an actuator for carrying the objective lens, and controlling the magnitude of the supplied volt to form corresponding electromagnetic forces which drive the objective lens in the horizontal and the vertical direction, so that a laser beam projected by the objective lens is focused on the optical disc for the read/write of an optical disc.

As indicated in FIG. 1, the actuator 1 according to the prior art includes a base 2, four elastic metallic wires 3 extended and connected to the two sides of the bearing 4 from the two sides of the base 2 respectively for supporting the bearing 4 to float in the base 2. The center of the bearing 4 carries an objective lens 5 which projects a laser beam. The bearing 4 is horizontally surrounded by a horizontal electromagnetic coil 6, and a vertical electromagnetic coil 7 is disposed at the front and the rear of the bearing 4. An L-shaped bottom board 8 is extended from the base 2, wherein two magnetic blocks 9 are respectively disposed at two ends of the bottom board 8, so that the bearing 4 is interposed between the two magnetic blocks 9. The actuator 1 provides appropriate volts to the horizontal electromagnetic coil 6 and the vertical electromagnetic coil 7 for generating electromagnetic forces respectively, wherein the electromagnetic forces generated by the two magnetic blocks 9 interact with and drive the bearing 4 to resist the elasticity of the four metallic wires 3 and accordingly shift vertically along the focusing direction F or horizontally along the tracking direction T.

As indicated in FIG. 2, an actuator 1 driving an objective lens 5 for performing focusing is shown. The actuator 1 of the prior art is fixed in optical pick-up head 10, and is shifted to the neighborhood of the target position of the optical disc 11 along with the optical pick-up head 10. That is, the actuator 1 generates an electromagnetic force by the volt to resist the elasticity of the metallic wires 3 and delicately shift the objective lens 5 to be positioned and focused at the target position. Since the elasticity of the metallic wires 3 is proportional to the electromagnetic force of the volt, the actuator 1 applies a fixed volt along the tracking direction T of shifting the objective lens 5 from the relative proportional position at the center not receiving the volt for controlling the objective lens 5 to be positioned along the tracking direction T. Likewise, for each position along the tracking direction T, a fixed volt V of shifting the objective lens 5 is provided along the focusing direction F for shifting the objective lens 5 for the same height H to control the shift of the focal point of the objective lens 5 along the focusing direction F so that the laser beam is focused on the data layer of the optical disc D.

Due to the assembly error of the actuator 1, the non-uniformity of material of the metallic wires 3, and the defects in coiling, the interaction between the electromagnetic coils (particularly in the peripheral where the magnetic field has larger change) incapacitates the objective lens 5 of shifting according to the magnitude of the volt, and results in a focusing height error h along the tracking direction T. In the closed loop focus control, the zero crossing focusing error enables the focal points at different positions along the tracking direction T to be locked on the data layer of the optical disc D. In the open loop (particularly the label surface where focusing cannot be applied), the focusing height error h at different positions along the tracking direction T cannot be eliminated, making the actuator unable to shift the objective lens 5 with sufficient precision so as to precisely focus the focal points on a particular position along the tracking direction T. Thus, the higher and higher requirements in the precision of read/write of the optical pick-up head cannot be met. Therefore, the actuator of the prior art still has the calibration problems to be resolved in the method of shifting the objective lens.

### SUMMARY OF THE INVENTION

According to a first aspect of the present invention, a method for calibrating an actuator is provided. A focus volt bias curve is formed by calibrating the focus volt at different positions along the tracking direction T in the actuator so as to increase the focusing precision of the actuator.

According to a second aspect of the present invention, a method for calibrating an actuator is provided. The reflective reference surfaces located different heights are used for calibrating the focusing heights of the actuator to form a focus volt bias curved surface to increase the shifting precision of the actuator along the focusing direction.

According to a third aspect of the present invention, a method for calibrating an actuator is provided. The focus volt level with respect to the label surface is directly compensated according to the focus volt bias curve obtained from calibration to improve the correctness in label printing.

To achieve the above objects of the invention, a method for calibrating an actuator is provided. A reflective reference surface is set. An objective lens is shifted to several calibration positions along the tracking direction in the actuator, focusing is performed at each position, and the shift volt and the focus volt are recorded. The focus volt at a calibration position is set as a standard focus volt, and the focus volt bias at the other calibration position with respect to the standard focus volt is calculated. A focus volt bias curve is formed by curve-fitting the focus volt bias and the shift volt at each calibration position, and the volt of the objective lens along the focusing direction is compensated by the focus volt bias obtained by interpolation or extrapolation and the shift volt of shifting the objective lens along the tracking direction in the actuator.

According to the method for calibrating an actuator of the invention, during the calibration of the focus volt for printing label, the label surface is set to face the objective lens, and label printing starts. A corresponding focus volt level is calculated from the pre-obtained focus volt level curve according to the printing position of the label surface. The focus volt bias at the printing position is calculated from the focus volt bias curve according to the shift volt of shifting the objective lens to be aligned to the printing position by the actuator. The focus volt level at the printing position is deducted by the focus volt bias to compensate the focus volt level for printing the label.

A method for calibrating an actuator is provided in another embodiment of the invention. Several reflective reference surfaces located different heights are set to face the actuator. Aimed to each reflective reference surface, the objective lens of the actuator is respectively shifted to several calibration positions along the tracking direction, focusing is performed at each position, and the shift volt and the focus volt are recorded. The focus volt at a calibration position is set as a standard focus volt, and the focus volt bias at the other calibration position with respect to the standard focus volt is calculated. A focus volt bias curved surface is formed by curve-fitting the bias with respect to the reflective reference surfaces located at different heights and the shift volt at each calibration position.

The invention will become apparent from the following detailed description of the preferred but non-limiting embodiments. The following description is made with reference to the accompanying drawings.

### BRIEF DESCRIPTION OF THE DRAWINGS

FIG. 1 shows a 3D view of an actuator according to the prior art.

FIG. 2 shows the actuator of the prior art performing focusing.

FIG. 3 shows an actuator of the invention performing calibration.

FIG. 4 shows a coordinate diagram of the calibration the records of the actuator of the invention.

FIG. 5 shows a focus volt bias curve of the actuator of the invention.

FIG. 6 shows a flowchart of a method for calibrating an actuator according to the invention.

FIG. 7 shows a schematic diagram of the method for calibrating the focus volt on the label surface according to the invention.

FIG. 8 shows a flowchart of the method for calibrating the focus volt on the label surface according to the invention.

FIG. 9 shows a diagram of proportional compensation for the height in any focusing direction according to the invention.

FIG. 10 shows a focus volt bias curved surface of the method for calibrating an actuator according to the invention.

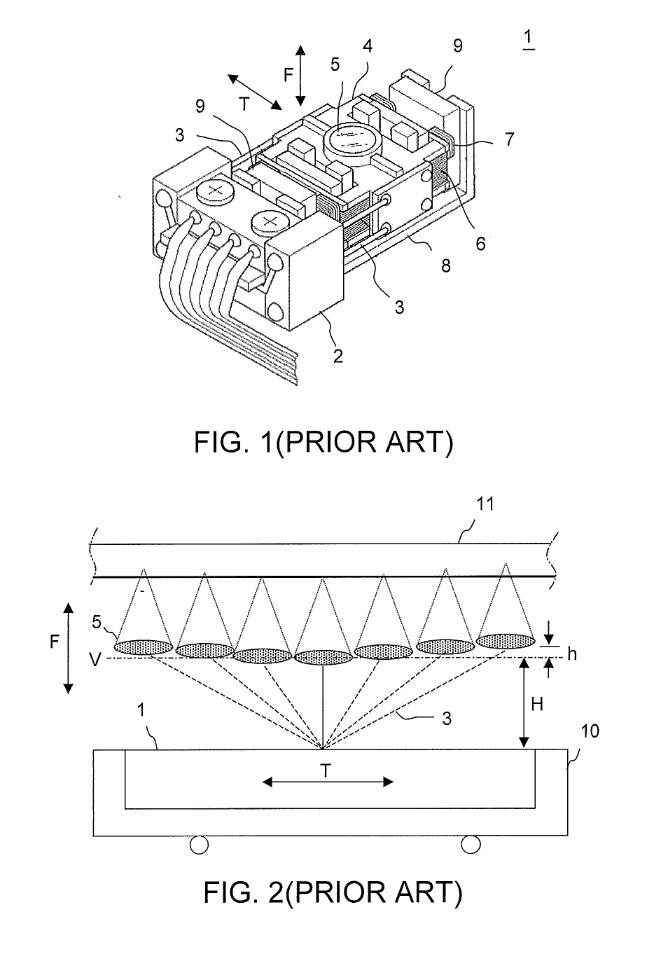

### DETAILED DESCRIPTION OF THE INVENTION

The technologies, means and effects adopted by the invention to achieve the above objects are exemplified below in a number of preferred embodiments with accompanying drawings.

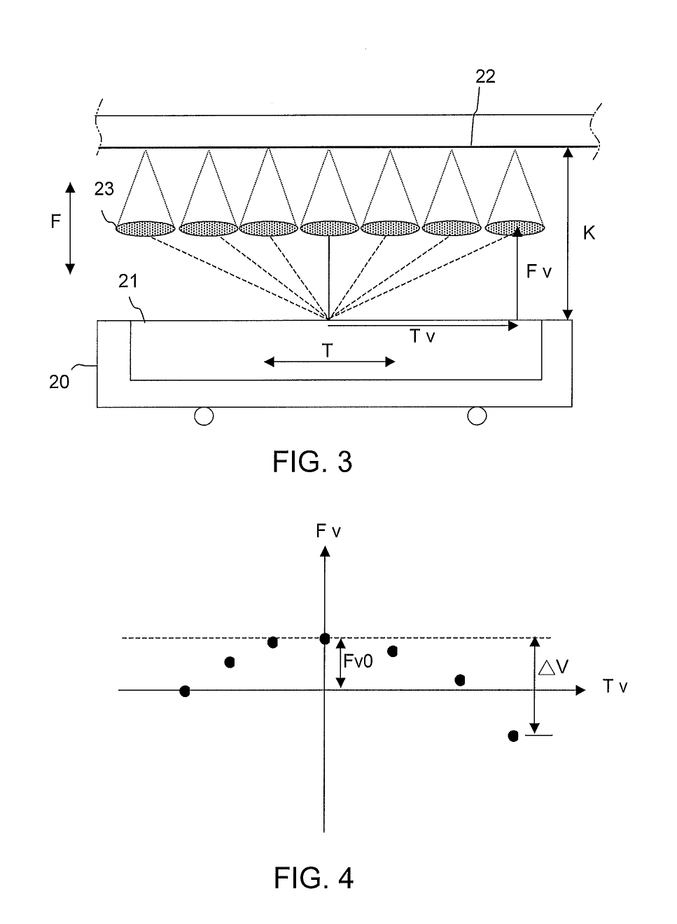

Referring to FIG. 3, an actuator of the invention performing calibration is shown. Firstly, an actuator 21 is shifted to face a reflective reference surface 22 by an optical pick-up head 20, wherein the reflective reference surface 22 is separated from the actuator 21 by a predetermined height K along the focusing direction F, and the reflective reference surface 22 can be replaced by the data layer or the label layer of an ordinary optical disc. Under an open loop, different shift volts Tv are respectively provided to the actuator 21 for diversely shifting the objective lens 23 to several calibration positions within the shift range along the tracking direction T. The calibration position preferably includes the position at which the shift volt Tv is equal to 0, that is, the objective lens 23 is located at the center of the actuator 21. At each calibration position, focusing is performed, the focus volt Fv is supplied, and the objective lens 23 is shifted vertically along the focusing direction F for projecting a laser beam onto the reflective reference surface 22 to reach a maximum light combined signal which is focused on the reflective reference surface 22, and the shift volt Tv and the focus volt Fv at the calibration position are recorded.

As indicated in FIG. 4, a coordinate diagram of the calibration the records of the actuator of the invention is shown. At each calibration position are illustrated in FIG. 4, the shift volt Tv and the focus volt Fv that are recorded. At a number of calibration positions, the focus volts Fv at a number of calibration positions with respect to the reflective reference surfaces with the same height are not the same. The focus volt at a calibration position is set as a standard focus volt Fv0. Since the objective lens is located at the center of the actuator where the shift volt Tv is equal to 0 and the electromagnetic interaction is minimized, the focus volt at the center of the actuator is preferably set as the standard focus volt Fv0. The bias ΔV of the focus volt Fv at other calibration positions with respect to the standard focus volt Fv0 is calculated.

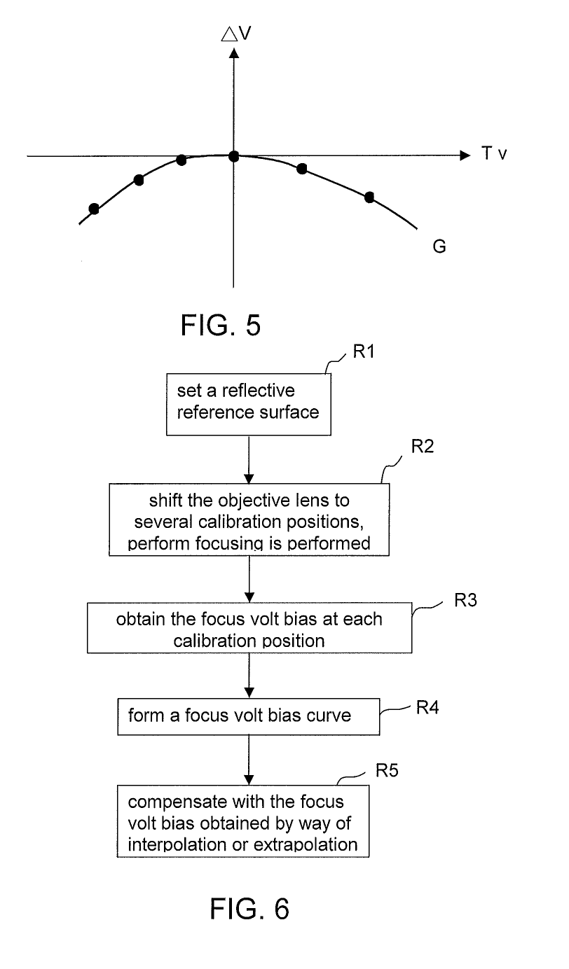

As indicated in FIG. 5, a focus volt bias curve of the actuator of the invention is shown. The focus volt bias ΔV calculated at each calibration position and the shift volt Tv are illustrated in FIG. 5. The focus volt bias curve G of the actuator can be formed by curve-fitting according to the calibration data obtained at several calibration positions. Thus, the predetermined height K, by which the reflective reference surface is separated from the actuator along the focusing direction F, is the distance between the actuator and the focus on the optical disc. For any positions to which the objective lens is shifted by the actuator along the tracking direction T, the focus volt bias with respect to the optical disc, which can be obtained by way of interpolating or extrapolating the focus volt bias curve G according to the shift volt Tv of shifting the objective lens, is used as a compensation for the volt of shifting the objective lens along the focusing direction F to calibrate the focusing shift error of the actuator.

The calibration process of the actuator of the invention is performed under an open loop as an exemplification. However, the calibration of the focus volt can also be performed under a closed loop. That is, based on the focusing error under a closed loop, the actuator can lock the focal point on the reflective reference surface, and retrieve the shift volts Tv and the corresponding focus volts Fv from several calibration positions including the position at which the shift volt Tv is equal to 0. Then, the focus volt bias curve P can be obtained according to the same calibration process disclosed above.

As indicated in FIG. 6, a flowchart of a method for calibrating an actuator according to the invention is shown. Detailed steps of calibrating the precision of the shift of the actuator according to the focus volt bias curve are disclosed below. Firstly, the method begins at step R1, the reflective reference surface with a predetermined height is set so that the actuator faces the reflective surface of the reflective reference surface. Next, the method proceeds to step R2, the objective lens is shifted to several calibration positions within the shift range of the actuator along the tracking direction T, focusing is performed at each position, and the shift volt Tv and the focus volt Fv at the calibration position are recorded, wherein the calibration position preferably includes the calibration position at which the shift volt Tv is equal to 0. Then, the method proceeds to step R3, the focus volt Fv at the calibration position at which the shift volt Tv is equal to 0 is set as a standard focus volt Fv0, and the bias ΔV of the focus volt Fv at the other calibration position with respect to the standard focus volt Fv0 is calculated. After that, the method proceeds to step R4, the focus volt bias ΔV and the shift volt Tv at each calibration position are calculated for forming the focus volt bias curve G of the actuator. Lastly, the method proceeds to step R5, the volt along the focusing direction F is compensated by the focus volt bias obtained by way of interpolating or extrapolating the focus volt bias curve according to the shift volt Tv of shifting the objective lens along the tracking direction T for calibrating the focusing shift error of the actuator.

Thus, according to the method for calibrating an actuator of the invention, a focus volt bias curve is formed by curve-fitting the shift volt and the focus volt at different calibration positions of the actuator along the tracking direction T, and the volt along the focusing direction F is compensated by a relative bias obtained by way of interpolation or extrapolation according to the shift volt Tv of shifting the objective lens along the tracking direction T, so as to increase the focusing shift precision of the actuator.

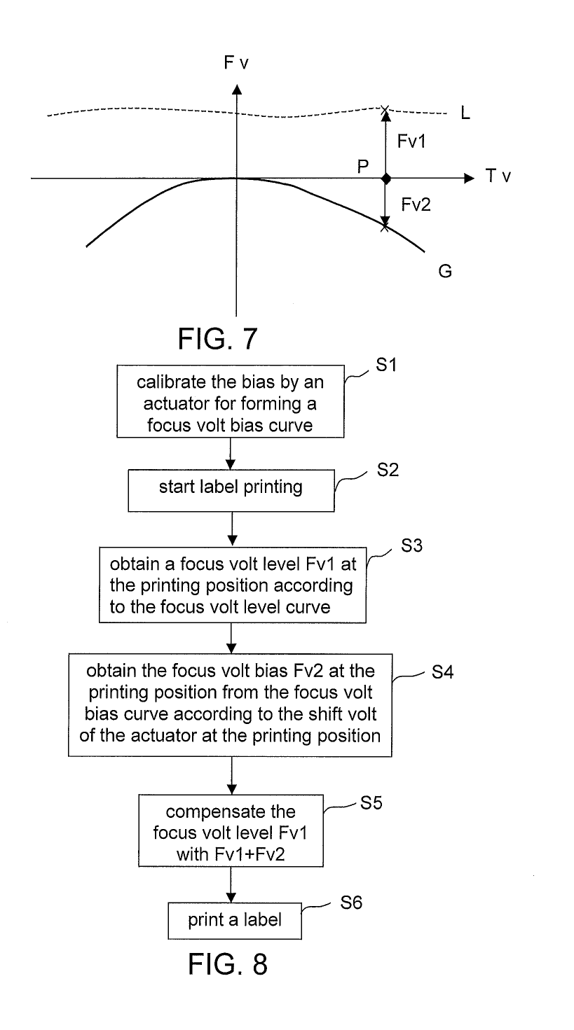

As indicated in FIG. 7, a schematic diagram of the method for calibrating the focus volt on the label surface according to the invention is shown. The invention method for calibrating an actuator can be used in a light scribe disc for printing a label pattern. Since the actuator cannot lock the focus on the label surface for printing the label pattern, in the prior art, a pre-obtained focus volt level curve L is used as a target volt of shifting the objective lens by the actuator along the focusing direction F. Thus, for any position P on the label surface at which a label is printed, a corresponding focus volt level Fv1 can be obtained from the focus volt level curve L by the actuator. When the actuator is near the position P, the shift volt Tv is used for fine-tuning the objective lens to be aligned to the position P. The focus volt level Fv1 cannot focus the focal point on the label surface due to the bias of the objective lens along the focusing direction, and the bias of the focus volt Fv2 is obtained from the focus volt bias curve G according to the shift volt Tv and used as compensation the shift volt Tv. Thus, the focus volt level Fv1 must compensate the bias Fv2, and a total focus volt level of Fv1+Fv2 is needed for focusing the focal point on the label surface so as to print a correct label pattern.

As indicated in FIG. 8, a flowchart of the method for calibrating the focus volt on the label surface according to the invention is shown. Detailed steps of compensating the focus volt on the label surface according to the method for calibrating an actuator are disclosed below. Firstly, the method begins at step S1, the bias is calibrated by an actuator for forming a focus volt bias curve. Next, the method proceeds to step S2, the label surface is set to face the objective lens and label printing starts. Then, the method proceeds to step S3, a corresponding focus volt level Fv1 is obtained from the focus volt level curve of the label surface according to the printing position of the label. After that, the method proceeds to step S4, the focus volt bias Fv2 at the printing position is obtained by way of interpolating or extrapolating the focus volt bias curve according to the shift volt Tv of shifting the objective lens to be aligned to the printing position by the actuator. Afterwards, the method proceeds to step S5, the focus volt level Fv1 is compensated and a total focus volt level of Fv1+Fv2 is achieved. Lastly, the method proceeds to step S6, the focal point is focused on the label surface for printing a correct label pattern.

Thus, according to the invention method for calibrating an actuator, the calibrated focus volt bias curve of the actuator and the focus volt level curve of the label surface directly compensate the focus volt level on the label surface and improve the focusing error on the label surface so as to increase the correctness in label printing.

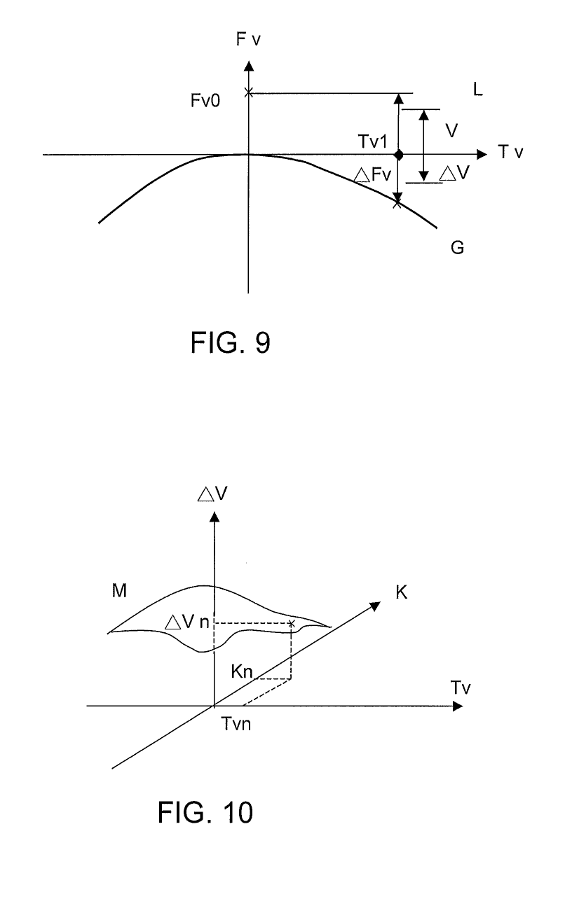

As indicated in FIG. 9, a diagram of proportional compensation for the height in any focusing direction according to the invention is shown. According to the above method for calibrating an actuator, the focal point on the reflective reference surface with a particular height (such as the data layer or the label surface of an optical disc) is calibrated. The volt of the focal point at respective height along the focusing direction is compensated as follows. Given the focus volt bias curve G with a particular height and a standard focus volt Fv0 thereof, the bias ΔV of the focus volt V is calculated according to the proportion of the standard focus volt Fv0 to the focus volt V of the actuator (that is, ΔV=(Fv0/V1)×ΔFv) to compensate the shift error of respective focusing height, wherein the focus volt bias ΔFv is obtained by way of interpolating or extrapolating the focus volt bias curve G according to the seating shift volt Tv1.

As indicated in FIG. 10, a focus volt bias curved surface of the method for calibrating an actuator according to the invention is shown. The present embodiment of the invention provides a method for obtaining the shift with higher precision and accuracy. Several reflective reference surfaces located different predetermined heights K are used. Aimed to each reflective reference surface with a predetermined height K, several shift volts Tv at the calibration position along the tracking direction are calibrated, the shift volt Tv and its corresponding focus volt Fv are recorded, a standard focus volt Fv0 is set, and the focus volt bias ΔV is calculated. A focus volt bias curved surface M is formed by curve-fitting the bias ΔV of the focus volt at each of the calibration positions corresponding to predetermined height K. When shifting the objective lens, the actuator controls the position of the objective lens along the tracking direction with the shift volt Tv and controls the height Kn that the objective lens needs to be shifted along the focusing direction. The focus volt bias ΔV is obtained by way of interpolating or extrapolating the corresponding point N on the focus volt bias curved surface M for compensating the shift volt of the actuator along the focusing direction.

In the present embodiment of the invention, a standard focus volt Fv0 is set for each reflective reference surface with a respective predetermined height K. Thus, the invention method for calibrating an actuator, the predetermined height K can be replaced by the standard focus volt Fv0 for forming a focus volt bias curved surface by curve-fitting. The focus volt bias is directly obtained from the focus volt bias curved surface by way of interpolation or extrapolation according to the shift volt of the actuator along the tracking direction and the focus volt in comparison to the standard focus volt Fv0 for increasing the shift precision of the actuator along the focusing direction.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for calibrating an actuator, wherein the method comprises the steps of:
(1) setting a reflective reference surface to face the actuator;
(2) shifting the objective lens of the actuator to a plurality of calibration positions along the tracking direction, performing focusing at each position, and recording the shift volt and the focus volt;
(3) setting the focus volt at a calibration position as a standard focus volt, and calculating the focus volt bias at the other calibration position with respect to the standard focus volt; and
(4) forming a focus volt bias curve by curve-fitting according to the focus volt bias and the shift volt at each calibration position.

2. The method for calibrating an actuator according to claim 1, wherein the reflective reference surface is a data layer of an optical disc.

3. The method for calibrating an actuator according to claim 1, wherein the objective lens is shifted to a plurality of calibration positions within the shift range of the actuator along the tracking direction.

4. The method for calibrating an actuator according to claim 3, wherein the calibration position comprises the center of the actuator at which the objective lens is located, and the focus volt where the objective lens are at the center of the actuator and the shift volt is equal 0 is set as the standard focus volt.

5. The method for calibrating an actuator according to claim 1, wherein the calibrating method is performed under an open loop.

6. The method for calibrating an actuator according to claim 1, wherein the calibrating method is performed under a closed loop.

7. The method for calibrating an actuator according to claim 1, wherein the volt with respect to the objective lens along the focusing direction is compensated with the focus volt bias obtained from the focus volt bias curve according to the shift volt where the objective lens shifting along the tracking direction in the actuator.

8. The method for calibrating an actuator according to claim 7, wherein the focus volt bias with respect to the objective lens is obtained by way of interpolating or extrapolating the focus volt bias curve.

9. The method for calibrating an actuator according to claim 1, wherein, after step (4), when the actuator calibrates the focus volt for printing a label, the method further comprises the steps of:
(4-1) setting a label surface of the label to face the objective lens and starting to print the label;
(4-2) calculating a corresponding focus volt level from the focus volt level curve of the label surface according to a printing position of the label surface;
(4-3) calculating the focus volt bias at the printing position from the focus volt bias curve according to the shift volt where the objective lens are aligned to the printing position by the actuator; and
(4-4) adding the focus volt bias at the printing position to the focus volt level at the printing position for compensating the focus volt level to print the label.

10. The method for calibrating an actuator according to claim 9, wherein the focus volt level curve is pre-obtained to use as a target volt for shifting the objective lens along the focusing direction by the actuator.

11. The method for calibrating an actuator according to claim 9, wherein the reflective reference surface is a label surface of an optical disc.

12. The method for calibrating an actuator according to claim 1, according to the proportion of the standard focus volt Fv0 to the focus volt V and the bias ΔFv obtained from the focus volt bias curve according to the shift volt by interpolating or extrapolating, the actuator obtaining the bias ΔV with respect to the focus volt V at different focal point heights along the focusing direction, wherein the bias ΔV is equal to Fv0/Δ×ΔFv.

13. A method for calibrating an actuator, wherein the method comprises the steps of:
(1) setting a plurality of the reflective reference surfaces located different heights to face the actuator;
(2) Aimed to each reflective reference surface, shifting the objective lens of the actuator to a plurality of calibration positions along the tracking direction, performing focusing at each position, and recording the shift volt and the focus volt;
(3) Aimed to the each reflective reference surface, setting the focus volt at a calibration position as a standard focus volt, and calculating the focus volt bias at the other calibration position of the each reflective reference surface with respect to the standard focus volt;
(4) forming a focus volt bias curved surface by curve-fitting according to the focus volt bias and the shift volt at each calibration position where the reflective reference surfaces are located at different heights.

14. The method for calibrating an actuator according to claim 13, wherein the objective lens is shifted to a plurality of calibration positions within the shift range of the actuator along the tracking direction.

15. The method for calibrating an actuator according to claim 14, wherein with respect to each reflective reference surface, the calibration position comprises the center of the actuator at which the objective lens is located, and the focus volt where the objective lens are at the center of the actuator and the shift volt is equal to 0 is set as the standard focus volt.

16. The method for calibrating an actuator according to claim 13, wherein in the step (4), the reflective reference surfaces located at different heights are replaced by corresponding standard focus volts for obtaining a focus volt bias curved surface by curve-fitting.
